(19) United States
(12) Patent Application Publication
(10) Pub. No.: US 2014/0173464 A1
(43) Pub. Date: Jun. 19, 2014

(54) PROVIDING APPLICATION CONTEXT FOR A CONVERSATION

(71) Applicants: Kobi Eisenberg, Yehud (IL); Ahi Gvirtsman, Yehud (IL); Boris Korenfeld, Yehud (IL); Olga Tubman, Yehud (IL)

(72) Inventors: Kobi Eisenberg, Yehud (IL); Ahi Gvirtsman, Yehud (IL); Boris Korenfeld, Yehud (IL); Olga Tubman, Yehud (IL)

(21) Appl. No.: 14/236,122

(22) PCT Filed: Aug. 31, 2011
(86) PCT No.: PCT/US11/50097

§ 371 Date: Jan. 30, 2014

(51) Int. Cl. H04L 29/06

(52) U.S. Cl. CPC H04L 65/403
USPC 715/753

(57) ABSTRACT

A method for providing application context for a conversation includes associating a conversation with an application object. A facet of the application object is obtained from a source application. A user interface is caused to display the obtained facet in conjunction with the conversation.

### BACKGROUND

Tools such as e-mail and chat enable participants to engage in conversations and collaborate on given topics. The context of such conversations is discerned by the participants reading the conversation. Initially, the context may be defined by a subject line. As an e-mail or chat thread grows with static files being added as attachments, the current topic of discussion can change over time. As a result, new and existing participants can find it cumbersome to discern the current context making it more difficult to take actions called for by the conversation.

### DRAWINGS

FIGS. 1-3 depict screen views of a user interface displaying a facet in conjunction with a conversation according to an example.

FIG. 4 depicts an environment in which various embodiments may be implemented.

FIG. 5 depicts a system according to an example.

FIG. 6 is a block diagram depicting a memory and a processor according to an example.

FIG. 7 is a block diagram depicting an implementation of the system of FIG. 3.

FIG. 8 is a flow diagram depicting steps taken to implement an example.

FIG. 9 is a communication sequence diagram according to an example.

### DETAILED DESCRIPTION

### Introduction

It is often the case that enterprise software applications, especially in IT organizations, are complex and cumbersome. The applications can require significant training and knowhow in order for a user to extract relevant information or perform specific actions of a given work flow. The information that a user consumes and the actions that are performed are often dynamic and defined by the context of that work flow. Before an action is taken, a user may collaborate with others to obtain perspective, guidance, or even permission. Conventionally, users, when faced with action items in a conversation, access and manipulate information in applications other than the tool used to collaborate. Various embodiments described below enable collaboration participants to consume the relevant application information and perform the corresponding actions based on the context of their work from within a collaboration tool.

An example of providing application context for a conversation includes associating a conversation with an application object, obtaining a facet for the application object from a source application, and causing a user interface to display the obtained facet in conjunction with the conversation. As a conversation evolves, the context of the conversation can be extended and involve additional application objects and facets. Thus, different facets can be persistently displayed with the conversation over time to provide an evolving application context.

As used, herein, a conversation is an electronic interaction between two or more participants concerning a particular topic or topics. The context of the conversation can involve application objects that are managed in various applications. An application object, as used herein, refers to an entity managed or otherwise controlled by an application. For example, a given IT application may manage infrastructure changes. An object for that application may then correspond to a particular infrastructure change or group of changes. In a different field of endeavor, an application may manage patents or other assets. An object for that application may then correspond to a particular patent or patent family.

Each object can have various facets. A facet is information associated with the object obtained from a source application. A facet, when displayed, conveys information relevant to the object and thus, provides application context to the conversation. As objects may be managed across multiple applications, different facets of a given object can include information from different source applications. A source application is an application capable of providing a facet or facets for any number of objects.

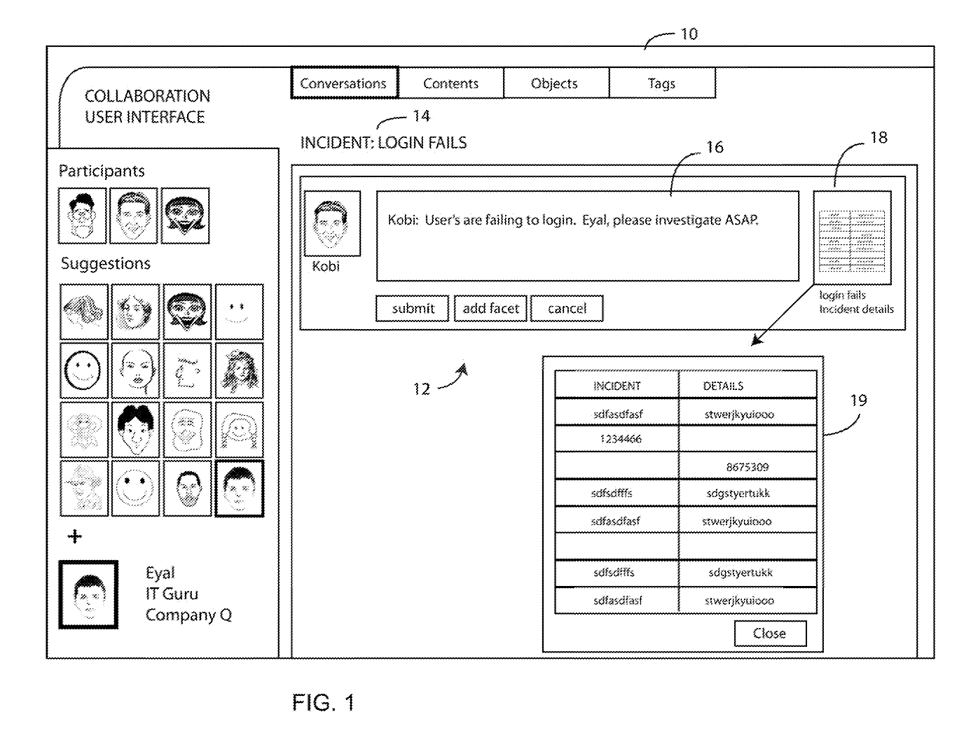

FIGS. 1-3 depict a user interface 10 of a collaboration tool. In the example of FIG. 1, user interface 10 is shown to include conversation 12 on topic 14. In FIG. 1, conversation 12 includes an initiating post 16 from a given participant. Facet 18 is displayed in conjunction with conversation 12. Facet 18, in this example, is a thumbnail representation or an icon representing the facet that when selected by a participant or viewer of conversation 12 causes the full facet 19 to be displayed. Both the thumbnail or icon facet and the full facet are considered displayed facets. User interface 10 may be generated by a collaboration tool in response to a call being made to that tool from an application. In one example, included in that call is data identifying an application object managed by the calling application or another application. Displayed facets 18, 19 are of that application object and thus provide application context to conversation 12. In another example, the participant entering post 16 may identify the application object through controls of the user interface 10. In yet another example, the text of post 16 of conversation 12 may be analyzed to identify a relevant application object in an automated fashion.

In FIG. 2, conversation 12 has grown to include posts 16 from a number of participants including the original post 16 of FIG. 1, and post 16′ currently being added to conversation 12. In the example of FIG. 2, facet 18 appears adjacent to the original post 16, facet 20 appears adjacent to a subsequent post 16, and facet 22 appears adjacent post 16′. In particular, facet 18 is of an application object defined by the original post 16 presented in FIG. 1. Facet 20 is of an application object corresponding to the subsequent post 16, and facet 22 is of an application object corresponding to the post being currently added. Thus, conversation 12 can include facets of multiple application objects that provide an evolving application context to conversation 12.

Displayed facets 18, 19, 20, and 22 of FIGS. 1 and 2 are static facets meaning that the information presented remains constant representing a state of the facet at the time a given post 16 was made. This static nature allows the conversation to be reviewed and better understood by others reviewing the work of the participants. 20. It can be desirable however, to utilize faces that are not static but actionable. Looking at FIG. 3, user interface 10 is displaying conversation 24 on topic 26. Conversation 24 is made up of existing posts 28 and a new post 28′ being added. Facet 30 is of an application object corresponding to new post 28′. Facet 30 is an actionable facet and includes user accessible controls 32 through which a participant can interact with a source application managing the particular application object. The information conveyed by facet 30 in this example is dynamic allowing conversation participants to control aspects of the application object that are relevant to the context of conversation 12.

The following description is broken into sections. The first, labeled “Environment,” describes an exemplary environment in which various embodiments may be implemented. The second section, labeled “Components,” describes examples of various physical and logical components for implementing various embodiments. The third section, labeled as “Operation,” describes steps taken to implement various embodiments.

Environment:

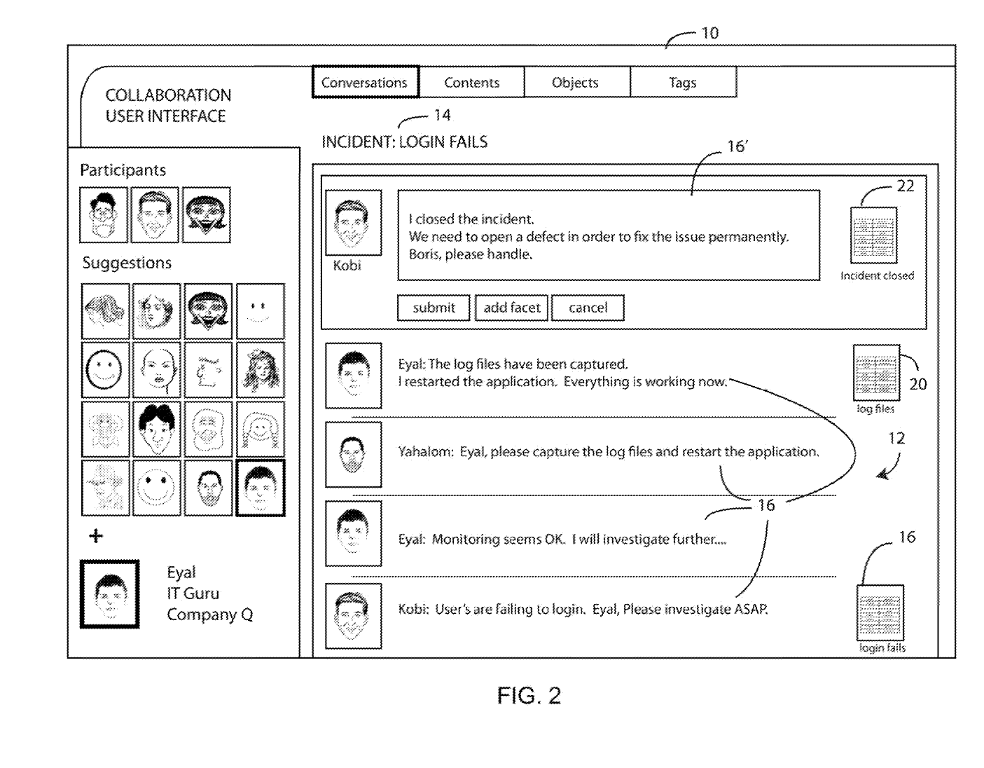

FIG. 4 depicts an environment 32 in which various embodiments may be implemented. Environment 32 is shown to include application services 34, collaboration service 36, and client devices 38. Application services 34 each represent a computing device or combination of computing devices configured to serve an application to client devices 38. Examples can include enterprise and consumer web and cloud applications provided through service oriented architectures.

Collaboration service 36 represents a computing device or combination of computing devices configured to serve a collaboration application to client devices 38. In particular, collaboration service 36 is configured to associate conversations with application objects, that is, objects managed by application services 34. The conversation, for example, may by conducted by participants utilizing client devices 38. Collaboration service 36 is further configured, in this example, to obtaining a facet of that associated application and to cause a user interface to display the obtained facet in conjunction with the conversation on one or more of client devices 38.

Client devices 38 each represent a computing device configured to interact with application services 34 and collaboration service 36. Such interaction may be through a browser or other application executing on a given client device 38. Link 40 represents generally one or more of a cable, wireless, fiber optic, or remote connections via a telecommunication link, an infrared link, a radio frequency link, or any other connectors or systems that provide electronic communication. Link 40 may include, at least in part, an intranet, the Internet, or a combination of both. Link 40 may also include intermediate proxies, routers, switches, load balancers, and the like.

Components:

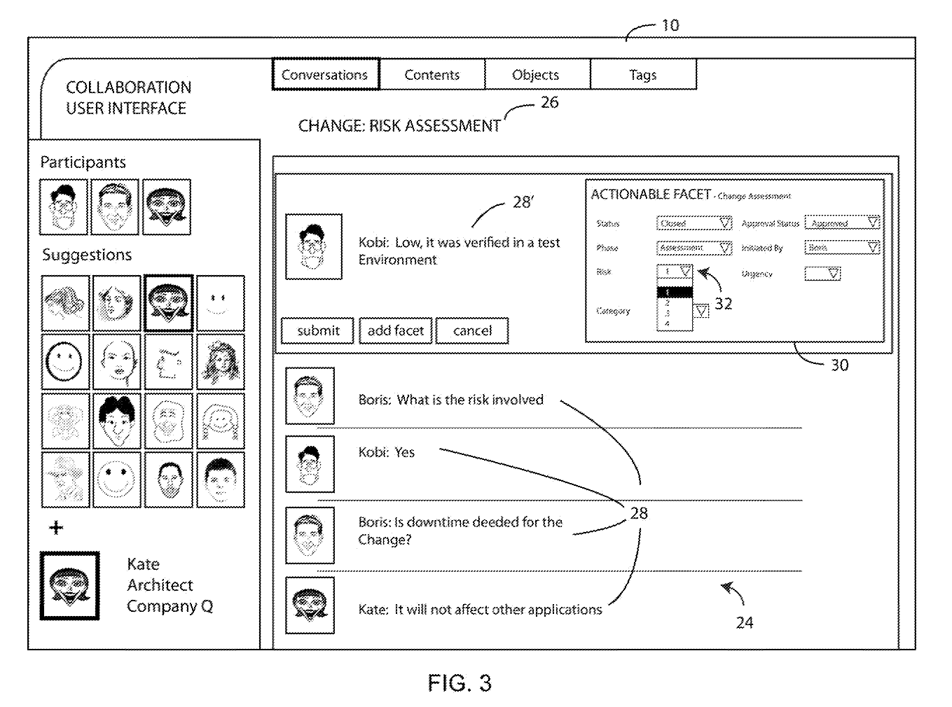

FIGS. 5-7 depict examples of physical and logical components for implementing various embodiments. FIG. 5 depicts system 42 for providing application context for a conversation. In the example of FIG. 5 system 42 includes context engine 44, facet engine 46, and interface engine 48. While system 42 is shown and discussed below to include engines 44, 46, and 48, it may also include one or both of collaboration engine 50 and adapters 52. Collaboration engine 50 represents generally any combination of hardware and programming configured to enable participants to post to an electronic conversation and serve an interface that when displayed presents that conversation for viewing by the participants.

Each adapter 52 is assigned to a source application from which a facet of an application object managed by that source application can be obtained. As will be discussed in more detail, each adapter 52 represents a combination of hardware and programming configured to, in response to a request, obtain facet data from the adapter's associated source application and return one of the facet data and a facet presentation assembled from the facet data. A facet presentation is electronic data in a format that is ready to be presented as part of a user interface. For example, a facet presentation may take the form of an HTML file and any accompanying data. Referring back to FIG. 1 as an example, a facet presentation may be for a thumbnail facet display such as facet 18, for a full facet display such as facet 19, or both. Facet data is electronic data that can be processed (into an HTML file for example) and then presented as part of a user interface as, for example, a thumbnail or full facet display, or both. Thus, a facet can include one or both of facet data and a facet presentation. In any case, the facet data or facet presentation contains electronic data indicative of an aspect of the corresponding application.

Context engine 44 represents generally any combination of hardware and programming configured to associate a conversation with an application object. In an example, an application, at the direction of a user, may make a call to collaboration engine 38 to initiate or join a conversation. That call can include data identifying an application object managed by the calling application. Context engine 44 may perform its function by associating the conversation with that application object. In another example, a conversation participant utilizing controls of the user interface displaying the conversation may identify the application object. In yet another example, context engine 44 may analyze the content of the conversation to identify a context and then identify an application object relevant to that context. In any event context engine 44 passes data identifying the application object on to facet engine 46.

Facet engine 46 represents generally any combination of hardware and programming configured to obtain a facet of the application object associated with the conversation. In performance of its functions, facet engine 46 may maintain a mapping of application objects to their corresponding adapters 52. Facet engine 46 communicates a request for the facet to an adapter 52 mapped to the application object in question. That request may include data identifying the application object. In response, facet engine 46 may receive a list of facets supported by the adapter 52 for that application object. Facet engine 46 can then return a request to adapter 5t for a selected one of the facets. Ultimately, facet data, a facet presentation, or both are returned to from adapter 52 and passed to interface engine 48.

Interface engine 48 represents generally any combination of hardware and programming configured to cause a user interface to display the obtained facet in conjunction with the conversation. As noted, interface engine 48 may receive one of a facet presentation and facet data obtained by facet engine 46. Where facet data is received, interface engine 48 processes the facet data to generate a default facet presentation. Interface engine 48 then causes the user interface to display the obtained facet presentation or the default facet presentation as the case may be. Such may be accomplished by passing the given facet presentation to collaboration engine 48 which in turn updates the user interface displaying the conversation to also include the facet. In another example, interface engine 48 may update the interface directly.

The facet caused to be displayed by interface engine 48 may be an actionable facet meaning that, when displayed, it includes user accessible controls for interacting with the corresponding application. In this case, interface engine 48 is also responsible for passing data indicative of manipulations of those user accessible controls to the source application managing the application object in question. Such may be accomplished by passing that data directly to the source application or to the adapter 52 assigned to the source application. In either event, the source application receives and ingests the data updating its state in a manner corresponding to the user's manipulation of the controls.

FIG. 3 provides an example of an actionable facet 30 being displayed in conjunction with conversation 12. Being displayed in conjunction with means that the facet is displayed at the same time and within visual proximity to the conversation to impart application context to the conversation. The proximal position promotes the valid presumption that the displayed facet is relevant to a context of the conversation. Thus the display of the facet in conjunction with the conversation aids the conversation participants in building the conversation and, if needed, reaching a resolution to an issue raised concerning the application.

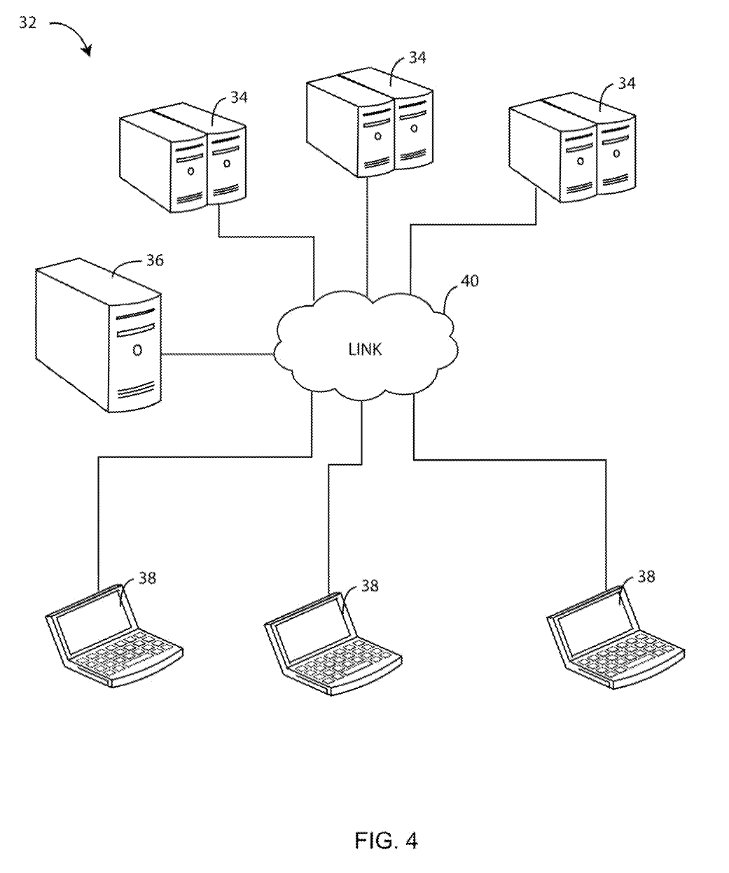

In foregoing discussion, various components were described as combinations of hardware and programming. Such components may be implemented in a number of fashions. Looking at FIG. 6, the programming may be processor executable instructions stored on tangible memory media 54 and the hardware may include a processor or processors 56 for executing those instructions. Memory 54 can be said to store program instructions that when executed by processor 56 implement system 42 of FIG. 5. Memory 54 may be integrated in the same device as processor 56 or it may be separate but accessible to that device and processor 56.

In one example, the program instructions can be part of an installation package that when installed can be executed by processor 56 to implement system 42. In this case, memory 54 may be a portable medium such as a CD, DVD, or flash drive or a memory maintained by a server from which the installation package can be downloaded and installed. In another example, the program instructions may be part of an application or applications already installed. Here, memory 54 can include integrated memory such as a hard drive, solid state drive, or the like.

In FIG. 6, the executable program instructions stored in memory 54 are depicted as context module 46, facet module 60, and interface module 62. Context module 58 represents program instructions that when executed cause the implementation of context engine 44 of FIG. 5. Facet module 60 represents program instructions that when executed cause the implementation of facet engine 46. Likewise, interface module 62 represents program instructions that when executed cause the implementation of interface engine 48. While not shown, memory 54 may also include a collaboration module corresponding to collaboration engine 50 and adapter modules according to adapters 52.

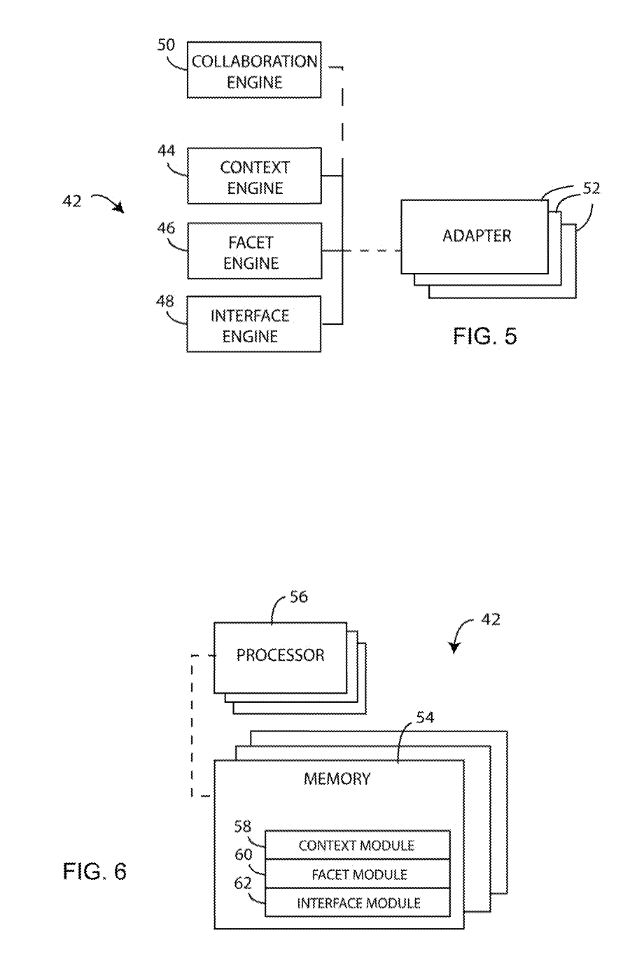

As a further example, FIG. 7 depicts a block diagram of environment 32 where system 42 of FIG. 5 may be implemented by any combination of application service 34, collaboration service 36, and client device 38. In the example of FIG. 5, application service 34 is shown to include memory 64, processor 66, and interface 68. Processor 66 represents generally any processor configured to execute program instructions stored in memory 64 to perform various specified functions. Interface 68 represents generally any interface enabling application service 34 to communicate via link 40 with client device 38 and collaboration service 36. Memory 64 is shown to include operating system 70 and applications 72. Operating system 70 represents a collection of programs that when executed by processor 66 serve as a platform on which applications 72 can run. Applications 72 represent program instructions that when executed by processor 66 can be served to client device 38.

Client device 36 is shown to include memory 74, processor 76, and interface 78. Processor 76 represents generally any processor configured to execute program instructions stored in memory 74 to perform various specified functions. Interface 78 represents generally any interface enabling client device 36 to communicate via link 40 with application service 34 and collaboration service 36. Memory 74 is shown to include operating system 80 and applications 82. Operating system 80 represents a collection of programs that when executed by processor 76 serve as a platform on which applications 72 can run. Applications 82 represent program instructions that when executed by processor 76 can consume applications served by application service 34 and collaboration service 36. Applications 82, for example, may include a web browser.

Collaboration service 36 is shown to include memory 84, processor 86, and interface 88. Processor 86 represents generally any processor configured to execute program instructions stored in memory 84 to perform various specified functions. Interface 88 represents generally any interface enabling collaboration service 36 to communicate via link 40 with application service 34 and client device 38. Memory 84 is shown to include operating system 90 and applications 92. Operating system 90 represents a collection of programs that when executed by processor 86 serve as a platform on which applications 92 can run. Applications 92 represent program instructions that when executed by processor 86 function serve a collaboration tool to client device 36. In particular, the program instructions, when executed, may function as collaboration engine 50 of FIG. 5.

Looking at FIG. 5, context engine 44, facet engine 46, interface engine 48, collaboration engine 50, and adapters 52 are described as combinations of hardware and programming. The hardware portions may, depending on the embodiment, be implemented as one or more of processors 66, 76, an 86 of FIG. 7. The programming portions, depending on the embodiment, can be implemented by one or more of operating systems 70, 80, and 90, one or more of applications 72, 82, and 92, or combinations thereof. In one example, system 42 of FIG. 5 may be implemented by processor 86 executing program instructions represented by applications 92. Where system 42 includes an adapter 52 (FIG. 5), that adapter 52 may be implemented by collaboration service 36, application service 34, or client device 38. System 42 may be distributed in other fashions across application service 34, client device 38, and collaboration service 36. Moreover, any two or all three of collaboration service 36, application service 34, and client device 38 may be integrated into a common service.

Operation:

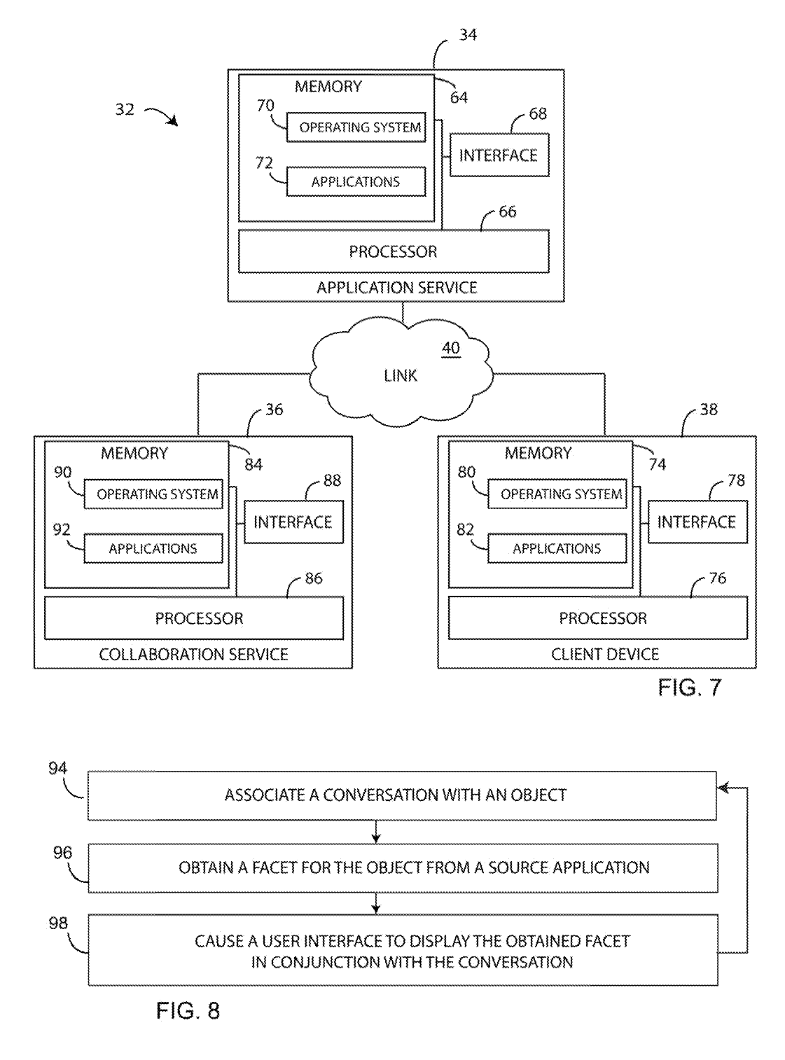

FIG. 8 is a flow diagram of steps taken to implement a method for providing application context for a conversation. In discussing FIG. 8, reference may be made to the diagrams of FIGS. 1-7 to provide contextual examples. Implementation, however, is not limited to those examples. A conversation is associated with an application object (step 94). Referring to FIG. 5, step 94 may be implemented by context engine 44. In an example, an application, at the direction of a user, may make a call to collaboration engine 50 to initiate or join a conversation. Step 94 may be accomplished by associating the conversation with an application object identified b the calling application or with an application object identified by a conversation participant. In another example, step 94 may be accomplished by associating a conversation manually by examining the conversation and identifying an application object related to the conversation's context.

A facet of the application is obtained from a source application (step 96). Obtaining a facet can include obtaining a facet that captures a state of the application object. Referring to FIG. 5, facet engine 46 may be responsible for implementing step 96 by communicating a facet request to an adapter 52 assigned or otherwise mapped to the associated application object and the source application. The adapter then acquires the facet from the source application and returns it. Ultimately, a facet in the form of a facet presentation or facet data may be returned.

A user interface is caused to display the obtained facet in conjunction with the conversation (step 98). Where facet data is received in step 96, step 98 includes assembling a default facet presentation from the facet data and causing the user interface to display the default facet presentation. Where a facet presentation is obtained in step 96, step 98 may simply include causing the user interface to display the obtained facet presentation. Referring to FIG. 5, interface engine 48 may be responsible for implementing step 98 and may accomplish the task by passing the default or obtained facet presentation to collaboration engine 50 which in turn generates or updates the user interface to incorporate the facet presentation with the conversation. The obtained face presentation can include either or both of a thumbnail version of the facet and a full version of the facet.

The facet obtained in step 96 may be an actionable meaning that, when displayed, it includes user accessible controls for interacting with the corresponding application. The method depicted in FIG. 8 may include passing data indicative of manipulations of those user accessible controls to the application responsible for managing the source object associated with the conversation. Referring to FIG. 5, such may be accomplished by interface engine 48 passing that data directly to that application or to the adapter 52 assigned to that application. In either event, the application receives and ingests the data updating the application object in a manner corresponding to the user's manipulation of the controls.

In an example, the source application may be one of a plurality of source applications. The method of FIG. 8 can then include providing each of the source applications with an adapter configured to, in response to a request for a facet, obtain facet data from the adapter's associated application and return one of the facet data and a facet presentation assembled from the facet data. In this example, step 96 can include requesting the facet from one of the adapters and receiving the facet data or the facet presentation from that adapter. Step 98 then includes, if facet data is received from that adapter, assembling a default facet present from the facet data and causing the user interface to display the obtained facet presentation or the default facet presentation in conjunction with the conversation.

In another example, step 96 can include identifying a plurality of facets available for the application object associated in step 94 and then obtaining a selected one of those facets. Where an adapter is used to obtain the facet, step 96 can include identifying an adapter that is configured to return a facet relevant to the application object associated with the conversation and then requesting the facet from that adapter. Such an adapter may be assigned or otherwise mapped to the given application object.

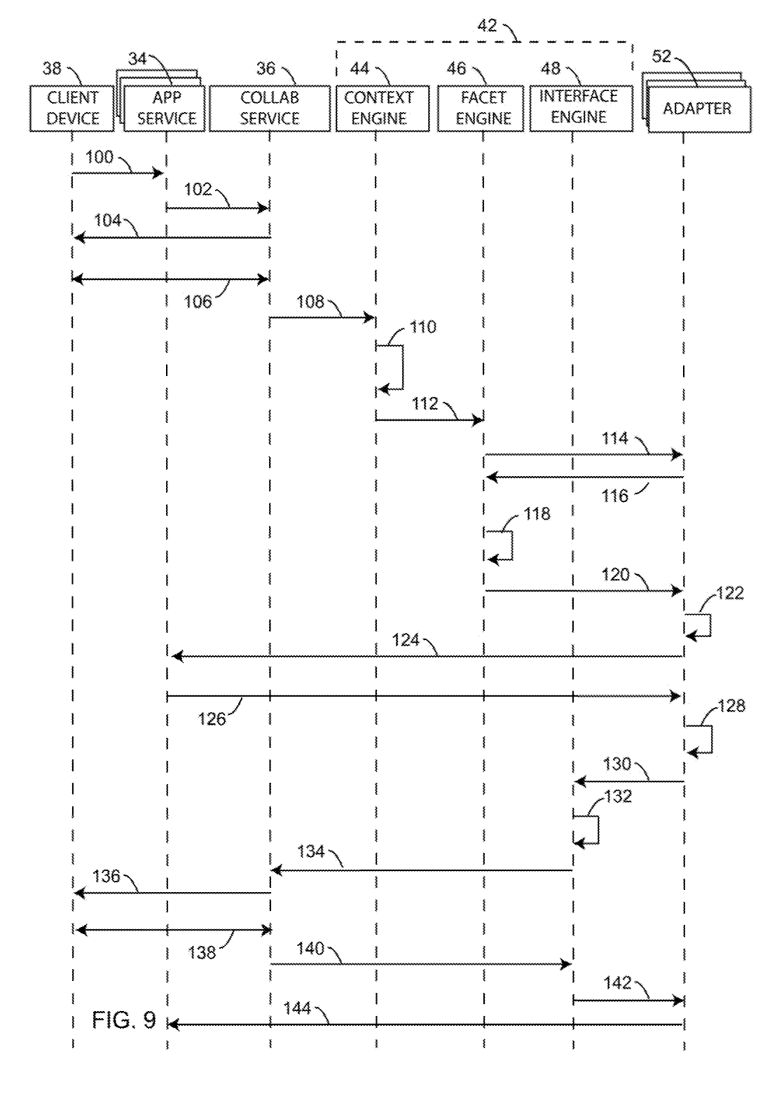

FIG. 9 is a communication sequence diagram of actions taken with respect to system 42 of FIG. 5 in environment 32 of FIGS. 4 and 7. Initially, client device 38 while consuming an application served by application service 34 requests access to collaboration service 36 to initiate or join a conversation (step 100). Where for example, an application interface is being displayed by a browser interface of client device 38, step 100 may be accomplished by a user selecting a control associated with a conversation function. Application service 34 passes the request to collaboration service 38 (step 102) which returns a user interface for the user to participate in and view a conversation (step 104). The user can then post to the conversation with collaboration service 36 updating the user interface accordingly (step 106).

Collaboration service 36 informs context engine 44 of the conversation and the call from application service 34 made in step 102 (step 108). Included in that information passed to context engine 44 may be information identifying an application object. Such information may be passed from application service 34 to collaboration service 36. Context engine 44 associates the conversation with the application object (step 110). Context engine 44 then communicates data identifying the application object to facet engine 46 (step 112).

Using the data communicated by context engine 44, facet engine 46 identifies adapter 52 assigned to the application object (step 114), and communicates a supported facet request to the identified adapter 52 (step 116). The supported facet request is a request for a list of facets supported by the adapter 52 for the given application object. Adapter 52 returns the list of supported facets (step 116), and facet engine 46 identifies a selected facet (step 118). Step 118 for example may include presenting the list to a user at client device 18 and receiving the user's selection.

Facet engine 46 then requests the selected facet of the application object associated with the conversation (Step 120). Based on the request of step 120, adapter 52 builds a query for use in retrieving the facet from the adapter's associated source application (step 122), which in this example is served by application service 34. Adapter 52 communicates the query to the source application (step 124) which in turn returns facet data (step 126). The facet data may capture a state of the application object that is relevant to the conversation.

Adapter 52 may process the facet data to generate a facet presentation (step 128). The facet data, the facet presentation, or both are communicated to interface engine 48 (step 130). If facet data is received, interface engine 48 assembles a default facet presentation from that facet data (step 132). Interface engine 48 passes the received facet presentation, if received in step 130, or the default facet presentation to collaboration service 36 (step 134). Collaboration service 36 then updates the user interface to display the facet presentation, default or otherwise, in conjunction with the conversation (step 136).

Where the facet presentation is for an actionable facet, collaboration service 36 updates the user interface to display selections made using the controls of the actionable facet (step 138). Collaboration service 36 passes data indicative of the selections to interface engine 48 (step 140) which in turn passes that data to adapter 52 for the corresponding application object (step 142). Adapter 52 passes the data on to its assigned application allowing the application's state to be updated accordingly (step 144)

### CONCLUSION

FIGS. 1-3 depict examples of a user interface 10 in which a facet of an application object is displayed in conjunction with a conversation. The particular layouts and designs of user interface 10 depicted in FIGS. 1-3 are examples only and intended to depict cases where facets are displayed proximal to a conversation to provide application context to that conversation. FIGS. 4-7 aid in depicting the architecture, functionality, and operation of various embodiments. In particular, FIGS. 4-7 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes, hard drives, solid state drives, random access memory (RAM), read-only memory (ROM), erasable programmable read-only memory, flash drives, and portable compact discs.

Although the flow diagram of FIG. 8 and the communication sequence diagram of FIG. 9 show specific orders of execution, the orders of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for providing application context for a conversation, comprising:
associating a conversation with an application object;
obtaining a facet of the application from a source application; and
causing a user interface to display the obtained facet in conjunction with the conversation.

2. The method of claim 1, wherein obtaining comprises:
identifying a plurality of facets for the application available from the source application; and
obtaining a selected one of the plurality of facets from the source application.

3. The method of claim 1, wherein:
obtaining a facet comprises obtaining one of facet data and a facet presentation; and
causing comprises:
if facet data is obtained then assembling a default facet presentation from the facet data; and
causing the user interface to display the obtained facet presentation or the default facet presentation in conjunction with the conversation.

4. The method of claim 1, wherein the facet is an actionable facet that when displayed includes user accessible controls, the method comprising passing data indicative of manipulations of the user accessible controls of the displayed actionable facet to the application.

5. The method of claim 1, wherein:
the source application is one of a plurality of source applications, the method comprising providing each of the plurality of source applications with an adapter, each adapter configured to, in response to a request for a facet, obtain facet data from the adapter's associated source application and return one of the facet data and a facet presentation assembled from the facet data;
obtaining comprises requesting the facet from one of the adapters and receiving the facet data or the facet presentation in response; and
causing comprises:
if facet data is received from that adapter then assembling a default facet present from the facet data; and
causing the user interface to display the obtained facet presentation or the default facet presentation in conjunction with the conversation.

6. The method of claim 5, wherein obtaining comprises:
identifying one of the adapters that is configured to return facet data or a facet presentation relevant to the application object associated with the conversation; and
requesting the facet from the identified adapter.

7. A system for providing application context for a conversation, the system comprising a context engine, a facet engine, and an interface engine, wherein:
the context engine is configured to associate a conversation with an application object;
the facet engine is configured to obtain a facet for the application object from a source application;
the interface engine is configured to cause a user interface to display the obtained facet in conjunction with the conversation.

8. The system of claim 7, wherein the facet engine is configured to:
identify a plurality of facets for the application available from the source application; and
obtain a selected one of the plurality of facets from the source application.

9. The system of claim 7, wherein the context engine is configured to associate the conversation with the application object by:
associating the conversation with an application object identified in a conversation call originating from an application managing the application object;
associating the conversation with an application object identified by a participant of the conversation; or
associating the conversation with an application object identified by an analysis of the conversation.

10. The system of claim 7, wherein:
the facet engine is configured to obtain one of facet data and a facet presentation; and
the interface engine is configured to:
if facet data is obtained then assemble a default facet presentation from the facet data; and
cause the user interface to display the obtained facet presentation or the default facet presentation in conjunction with the conversation.

11. The system of claim 7, wherein the facet is an actionable facet that when displayed includes user accessible controls, and wherein the interface engine is configured to pass data indicative of manipulations of the user accessible controls of the displayed actionable facet to the application.

12. The system of claim 7, wherein:
the source application is one of a plurality of source applications and the system comprises an adapter associated with each of the plurality of source applications, each adapter configured to obtain facet data from its associated source application and return one of the facet data and a facet presentation assembled from the facet data;
the facet engine is configured to obtain a facet by requesting the facet from one of the adapters and receiving facet data or a facet presentation in response; and
the interface engine is configured to:
if facet data is received then assemble a default facet presentation from the facet data; and
cause the user interface to display the received facet presentation or the default facet presentation in conjunction with the conversation.

13. The system of claim 12, wherein the facet engine is configured to obtain by:
identifying one of the adapters that is configured to return facet data or a facet presentation relevant to the application object associated with the conversation; and
requesting the facet from the identified adapter.

14. A computer readable medium having instructions that when executed by a processor implement a system for providing application context for a conversation, the system comprising a context engine, a facet engine, and a interface engine, wherein:
the context engine is configured to associate a conversation with an application object;
the facet engine is configured to obtain a facet of the application object from a source application;
the interface engine is configured to cause a user interface to display the obtained facet in conjunction with the conversation.

15. The medium of claim 14, wherein the facet engine is configured to:
identify a plurality of facets for the application available from the source application; and
obtain a selected one of the plurality of facets from the source application.

16. The medium of claim 14, wherein the context engine is configured to associate the conversation with the application object by:
associating the conversation with an application object identified in a conversation call originating from an application managing the application;
associating the conversation with an application object identified by a participant of the conversation; or
associating the conversation with an application object identified by an analysis of the conversation.

17. The medium of claim 14, wherein:
the facet engine is configured to obtain one of facet data and a facet presentation; and
the interface engine is configured to:
if facet data is obtained then assemble a default facet presentation from the facet data; and
cause the user interface to display the obtained facet presentation or the default facet presentation in conjunction with the conversation.

18. The medium of claim 14, wherein the facet is an actionable facet that when displayed includes user accessible controls, wherein the interface engine is configured to pass data indicative of manipulations of the user accessible controls of the displayed actionable facet to the application.

19. The medium of claim 14, wherein:
the source application is one of a plurality of source applications each source application being associated with an adapter configured to, in response to a request for a facet of its associated application, obtain facet data from that application and return one of the facet data and a facet presentation assembled from the facet data;
the facet engine is configured to obtain a facet by requesting the facet from one of the adapters and receiving facet data or a facet presentation in response; and
the interface engine is configured to:
if facet data is received then assemble a default facet present from the facet data; and
cause the user interface to display the received facet presentation or the default facet presentation in conjunction with the conversation.

20. The medium of claim 20, wherein the facet engine is configured to obtain by:
identifying one of the adapters that is configured to return facet data or a facet presentation relevant to the application object associated with the conversation; and
requesting the facet from the identified adapter.
